(19) United States
(12) Patent Application Publication
(10) Pub. No.: US 2017/0060601 A1
(43) Pub. Date: Mar. 2, 2017

(54) METHOD AND SYSTEM FOR INTERACTIVE USER WORKFLOWS

(71) Applicant: EXALTIVE INCORPORATED, Redmond, WA (US)

(72) Inventors: Vikas JOSHI, Maharashtra (IN); Roger WOEHL, Novato, CA (US)

(21) Appl. No.: 15/245,482

(22) Filed: Aug. 24, 2016

(30) Foreign Application Priority Data
Aug. 24, 2015 (IN) 3211/MUM/2015

(51) Int. Cl. G06F 9/44; G11B 27/036

(52) U.S. Cl. CPC G06F 9/4446; G11B 27/036

(57) ABSTRACT

The present invention relates to a simplified system and method thereof for creating video guided application workflows where a plurality of users can interact directly with a plurality of application input controls that are displayed on at least one screen area of at least one screen, wherein the plurality of application input controls are displayed on the same screen as the video and in sequence with the timeline so that the video content can direct the user actions.

### CROSS-REFERENCE TO A RELATED APPLICATION

This application claims priority to India Patent Application No. 3211/MUM/2015, filed Aug. 24, 2015, which is incorporated herein by reference in its entirety.

### BACKGROUND

A. Technical Field

The present invention relates to a method and system for creating interactive user workflows, more particularly the invention relates to a single screen user interface that guides a user through a software workflow process by merging user input controls with in the flow of a video and uses the video content to provide examples, information, and motivation in timed sequence with the display of user input controls.

B. Background of the Invention

Over a decade or so the effective user interface design technology has developed tremendously. The traditional methods to support effective user interfaces are varied, but can generally be described as methods to simplify the user input forms and to provide additional contextual information that may help the users. Most specifically a designer attempts to merge help information within the interface to the existent possible to eliminate the need for users to view multiple screens to first learn about the requirements and then later apply that information in the software.

The need for effective user interface design is most apparent in mobile smart phones where small screen design limits the options, and where users need very rich and compelling content to stay focused.

In the realm of web application design many methods are used to merge help with applications, and these can include a pop-up help screen or a Tips screen that adds additional text information or images on the screen. Another method uses a transparent Overlay to present text help information about the underlying screen. The methods can provide some simple levels of added information but lack the ability to deliver rich details, examples, or motivation.

Video has long been used as a training tool for software, and traditionally this involved creating separate training content that included both explanation and examples. Video has also been used to motivate or inspire action, as is commonly the case in advertisements. Some web applications have used video help files, however these have been implemented as separate screens, pop-up views, or split screens, all of which can create separate user experiences that results in a disruption of a user workflow process.

Another approach is to use an interactive video that employs a type of overlay on the video that can present additional information or user controls in conjunction with the video timeline. Several technologies exists for creating standalone interactive video that support annotations, in-video navigation buttons, and configurable controls that allow information like test and quizzes to be collected in the video. While helpful in some cases to navigate the video or collect supplemental information, these tools do not allow the viewer to directly interact with application controls. Such interactive videos have been used to create interactive story telling, or to create videos with a clickable region that can link users to other web sites such as shopping sites where items in the video can be purchased.

Other technologies such as flash allow programmers to create an interactive video that can collect application information, however, a programmer needs to create specialized forms or user input controls within the flash framework, and further they need to create specialized methods to move data to and from the flash interface. Technologies like flash have limited support in mobile phone devices.

The most sophisticated examples of user adoption of complex software comes in video game design were teams of programmers and graphic designers can take advantage of sophisticated graphics engines to create immersive experiences that combine rich computer animation with user input controls. While effective at building wide adoption in game consoles, these interfaces are expensive to build and maintain, and they have not proven effective in web-based applications were constrained bandwidth, processing, and development cost have made this impractical.

While the need exists to create rich, compelling, and motivating user experiences for applications, the current approaches do not provide a cost effective method for designers to leverage there existing web controls in a user experience that seamlessly merges effective video content with application controls on a single screen to produce a rich and compelling user experience that works on both desktop and smart phone devices.

For the reasons stated above, which will become apparent to those skilled in the art upon reading and understanding the specification, there is a need in the art for a system and method for creating a single screen user interface that guides a user through a software workflow process that is usable, scalable and independent of new technology platforms, uses minimum resources that is easy and cost effectively maintained and is portable and can be deployed anywhere in very little time.

### SUMMARY OF THE INVENTION

The present invention relates to a simplified system and method thereof for creating video guided application workflows where a plurality of users can interact directly with a plurality of application input controls that are displayed in at least one screen area of at least one screen, wherein the plurality of application input controls are displayed in the same screen as the video and in sequence with the timeline so that the video content can direct the user actions.

Further the invention relates to a system and method thereof that allows web application designers to present their existing a plurality of application controls in at least one video in a manner that is secure, scalable, and easy to maintain.

Further still the invention relates to a system and method thereof of presenting a plurality of web application controls in at least one video that accounts for a plurality of application needs, including input validation, error messages, branching navigation controls, forward and backward navigation, and other such means as are needed for the at least one video to serve as at least one driver for at least one application workflow.

Further the invention relates to system and method thereof for creating an optimized user experience for first time or occasional tasks that incorporate behavioural motivation cues presented in the at least one video content that are coupled with the corresponding at least one application input so as to inspire a user to complete tasks wherein the at least one user might not otherwise persevere.

Finally the invention relates to a plurality of toolset means to effectively create at least one video driven workflow and to efficiently deploy the at least one workflow to at least one application and to measure and monitor its effectiveness.

### BRIEF DESCRIPTION OF THE DRAWINGS

FIG. 1 is an example of a single screen workflow system in accordance with at least one embodiment.

FIG. 2 is an example of mapping of the time events on the video.

FIG. 3 is a system diagram according to at least one embodiment.

FIG. 4 is an example of interactive time event mapped on a video screen.

FIG. 5 is an example of interactive time event mapped on a web page.

FIG. 6 is an example of interaction analytics generated by the system.

FIGS. 7A-7B are examples of interaction analytics generated by the system.

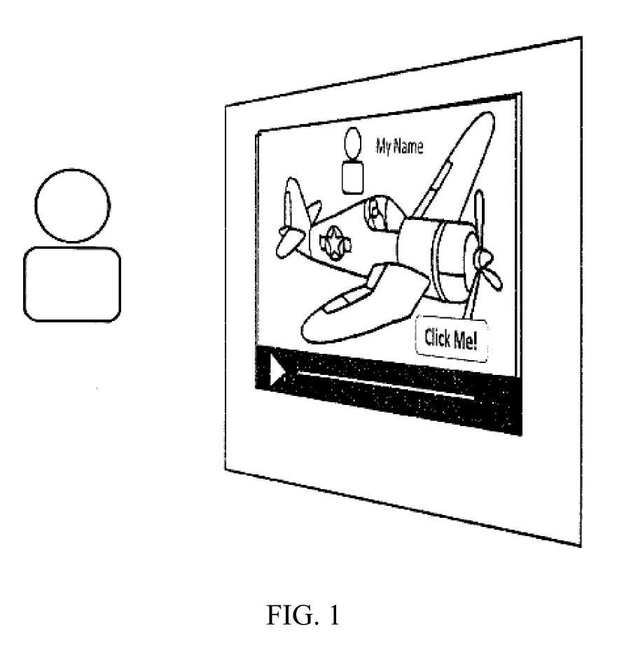

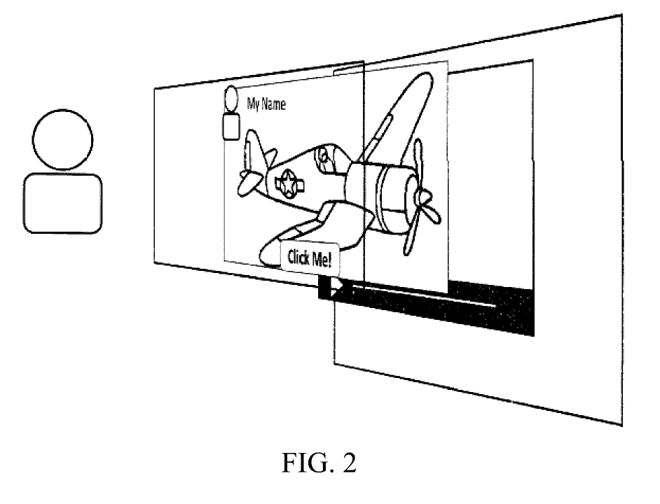

### DETAILED DESCRIPTION OF THE PREFERRED EMBODIMENTS OF THE INVENTION

The invention described herein is directed to create a single screen user interface that effectively guides a plurality of users through at least one interactive video based software workflow process. The single screen user interface is created by merging user input controls with in the flow of a video, and further a method that uses the video content to provide examples, information, and motivation in timed sequence with the display of a plurality of user input controls overlaid on the at least one video to collect information.

The embodiments herein provide a method and system for creating at least one single screen user interface that guides a plurality of user through at least one software workflow process by merging a plurality of user input controls with in the flow of at least one video, and further a method that uses the at least one video content to provide examples, information, and motivation in timed sequence with the display of the plurality of user input controls overlaid on the at least one video to collect information. Further the embodiments may be easily implemented in various data and information management structures. The method of the invention may also be implemented as application performed by a stand alone or embedded system.

The invention described herein is explained using specific exemplary details for better understanding. However, the invention disclosed can be worked on by a person skilled in the art without the use of these specific details.

References in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

Hereinafter, the preferred embodiments of the present invention will be described in detail. For clear description of the present invention, known constructions, and functions will be omitted.

Parts of the description may be presented in terms of operations performed by a computer system, using terms such as data, state, link, fault, packet, FTP and the like, consistent with the manner commonly employed by those skilled in the art to convey the substance of their work to others skilled in the art. As is well understood by those skilled in the art, these quantities take the form of data stored/transferred in the form of electrical, magnetic, or optical signals capable of being stored, transferred, combined, and otherwise manipulated through mechanical and electrical components of the computer system; and the term computer system includes general purpose as well as special purpose data processing machines, switches, and the like, that are standalone, adjunct or embedded.

According to an embodiment, the present invention, relates to dynamic interactive video driven workflows, and more particularly to a system and method thereof for merging video with a plurality of application controls in at least one single screen so that a plurality of users can interact with an application when prompted by video content that may include information, examples, encouragement and other means to maximize the likelihood that a user will successfully complete a process.

Creating a simple interface for users is a critical need for any software application that intends to build wide adoption. This need is particularly true when users are exposed to the application for the first time a need to complete specific steps in order to sign up, set up, and learn about the software. The need is amplified when the steps needed in initial stages are complex, and/or, the users might have a limited amount of time, attention, or background information needed to complete the steps. In such cases creating a user experience that helps the user to complete the process is essential. The problem is most acute when dealing with a small screen design, such as a mobile phone, were very limited space is available to provide user interface controls, explanations, help, etc.

An additional factor for new software is that not only does the process need to be easy to complete, but in many cases the user needs some motivation to encourage them to take the time and effort to complete a sign up and setup process. This level of motivation is as much an emotional component to completion as is the technical simplicity.

In its simplest embodiment, the invention comprises at least one interactive video player inserted into at least one application user interface screen containing at least one user interface control, at least one video file, and at least one related event instruction set. When started, the at least one player will play the at least one video file and evaluate time events defined in the event instruction set. When a match is found between a defined time event and the video play time, at least one instruction is executed to achieve some desired effect. For instance at least one user interface component can be made to appear over the video in at least one defined location so that from at least one viewer's perspective the component appears as a part of the video. The interface component can allow the at least one viewer to provide at least one input as appropriate.

One of the preferred embodiment of this invention would be a web page that includes one or more viewer input controls such as buttons or form fields, the interactive video player, a video file, and an instruction set. At defined video time points, the instruction interpreted by the player can cause the input controls to be presented over the video player to give the appearance of being a part of the video.

Expanding upon one of the preferred embodiment, specialized instructions in the instruction set can allow the player and user input component to coordinate so that the video player could pause or loop the video while waiting for user inputs, then when input is provided the video player could continue. Adding to this, the inputs to the controls could be stored and used a in a later instruction to alter what the video timeline, or to change the behaviour of the components defined in the instruction set.

Extending further, the interactive player can interact with other functions on the page that may be non-visible to the at least one viewer, for example some code function called or method whose results may not be visible to the viewer.

Interactive video player can be constructed as a reusable component capable of accepting different video files and instruction sets, so that a common player component can be used to present different video driven workflow by providing different instructions sets and related video and screen controls.

Expanding further, at least one visual tool can be employed to provide a designer with at least one simple interface to create a plurality of instructions sets without the need to directly programmatically write complex instructions. Through the tooling the designer can specify at least one video file, the plurality of controls that will used in the video, and timeline event details like when the control will appear and disappear, as well as additional properties about the appearance and behaviour of the control or video player, including for instance: display location, color, and size, etc.

In addition to an input controls for display, a toolset supports other visual representation of other types of instructions. A dynamic branching container could accept at least one data variable into a conditional statement that would select a segment of the video most relevant to the viewer.

In still another embodiment of the invention the at least one video player includes a method to track and report the behaviour of the viewer including recording the time spent viewing each action of the video, and the actions taken on each input or control by the viewer while viewing. The data collected can be saved in a common repository allowing for analytics that give the designer input on how the video and corresponding application was utilized.

In another embodiment of the invention the video workflow can be deployed as a cloud service so that the tools, video player, interactive instruction set, and analytics can be hosted on an external cloud server. The video workflow can be created with the tools accessed through a web browser. Embedding of the player can be done by means of at least embedded instruction set with an external reference to the player and corresponding instruction set.

As per one of the preferred embodiment of the present invention the method for creating interactive user workflow comprises of inserting an interactive video player into an application user interface screen, receiving at least one video file, receiving at least one event instruction set, playing the video files, evaluating time events defined in the event instruction set by time event engine, executing an instruction to achieve desired effect when q match is found between a defined time event and the video play time, tracking the behaviour of the viewer/user, generating analytics based on the events, interactive and tracked data by the analytic engine. The method defines the time events in the instruction set based on the events expected to be executed and the interactive behaviour expected at the time event from at least one user. The time line event details includes but not limited to detailed properties about the appearance and behaviour of control and video played including display location, colour, size etc. As per the method by executing an instruction a user interface component is made to appear over the video in a defined location so that from a viewer's perspective the component appears as part of the video. As per the method executing an instruction, the instruction in the instruction set allows the player and user input component to coordinate, so that the video player could pause or loop video while waiting for user inputs and the video player is allowed to continue upon receiving inputs provided the video player. As per the method a dynamic branching container could accept at least one data variable into a conditional statement that would select a segment of the video most relevant to the viewer. The behaviour of the viewer is tracked. Tracking the behaviour of the viewer includes but not limited to recording the time spent viewing each action of the video, and the actions taken on each input or control.

The method is directed to create a single screen workflow experience that includes both video and user inputs in the same space. According to the method the interactive video designer visualize when and where dynamic data or controls will be displayed in the video during an editing process where it is not connected to the web application. The method collects the analytics pertaining to actions in the video.

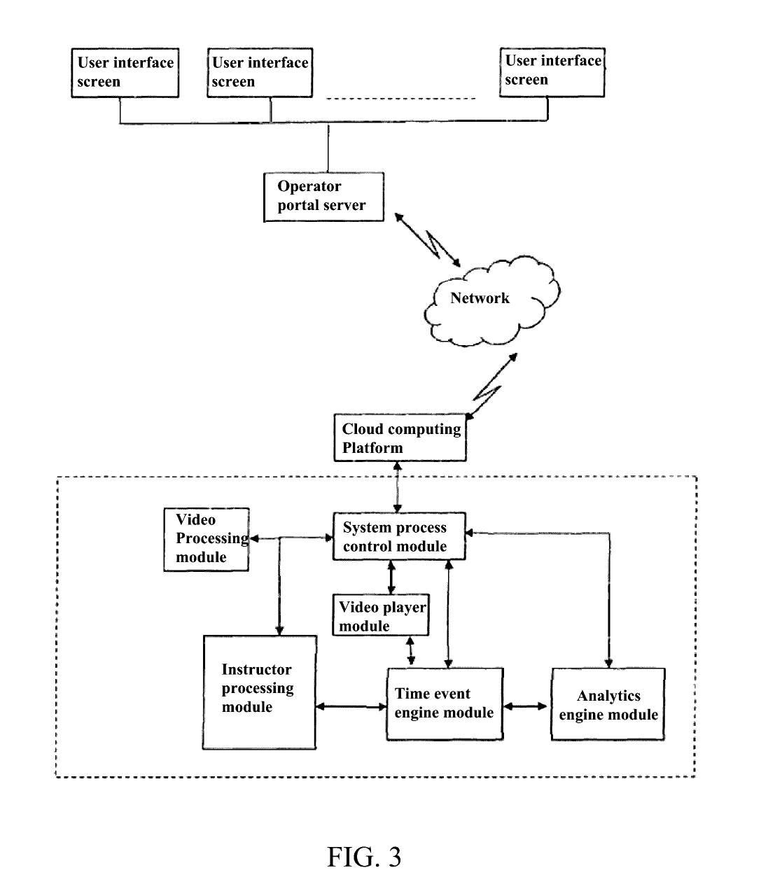

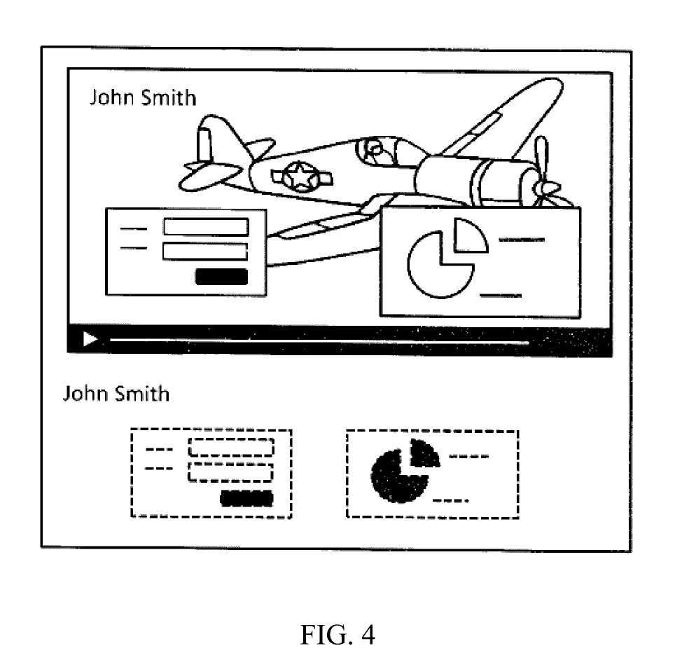

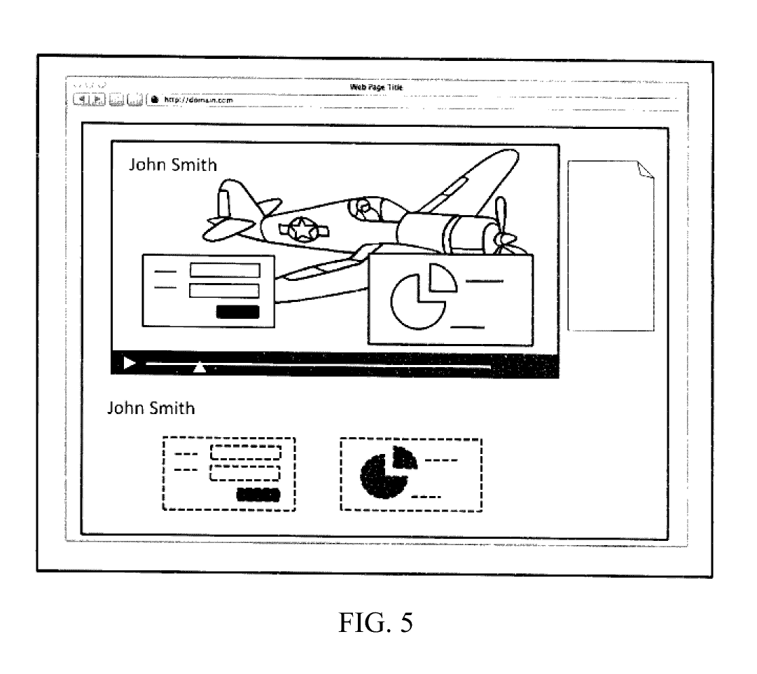

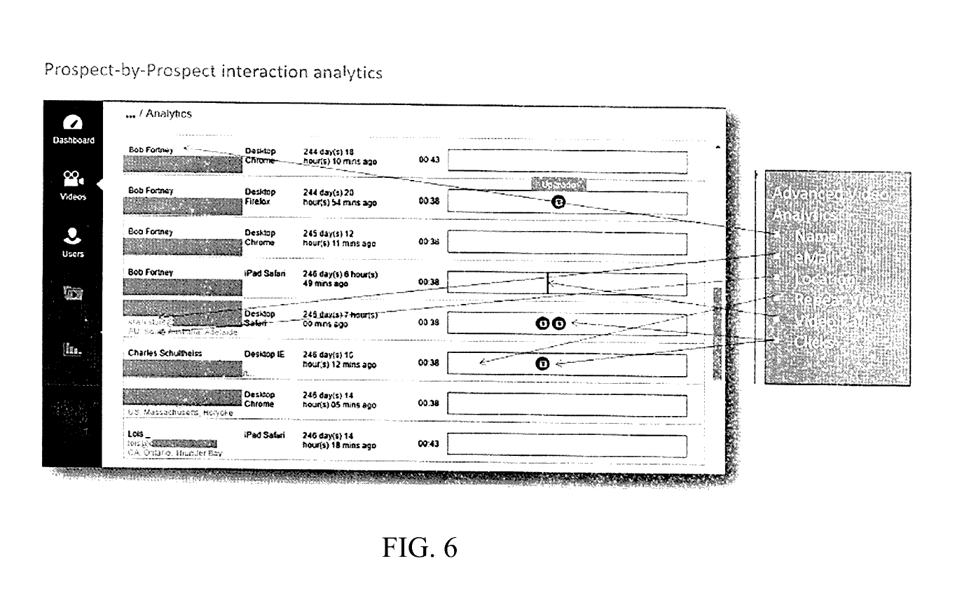

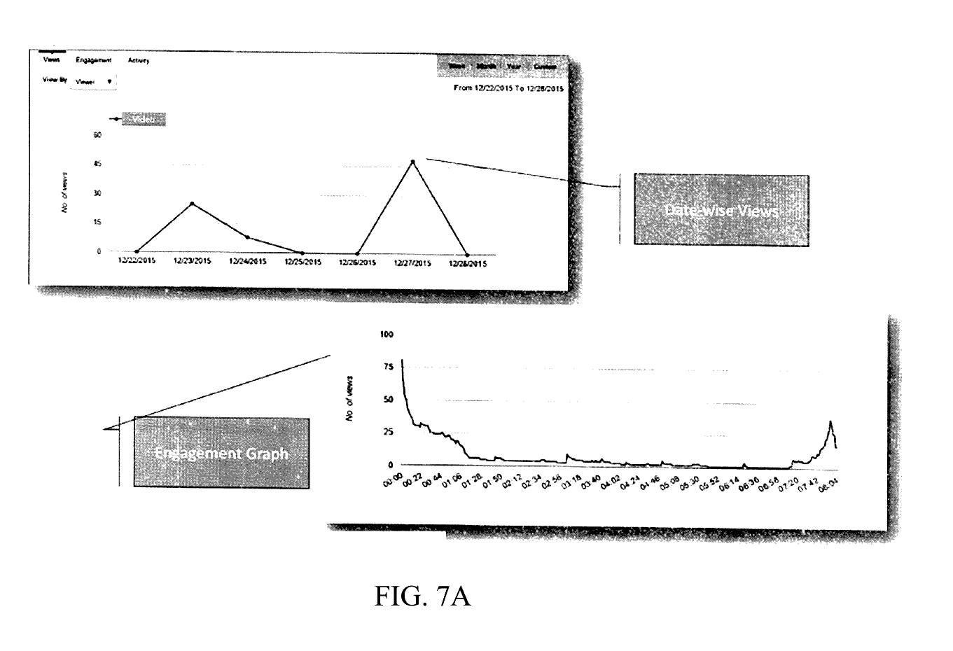

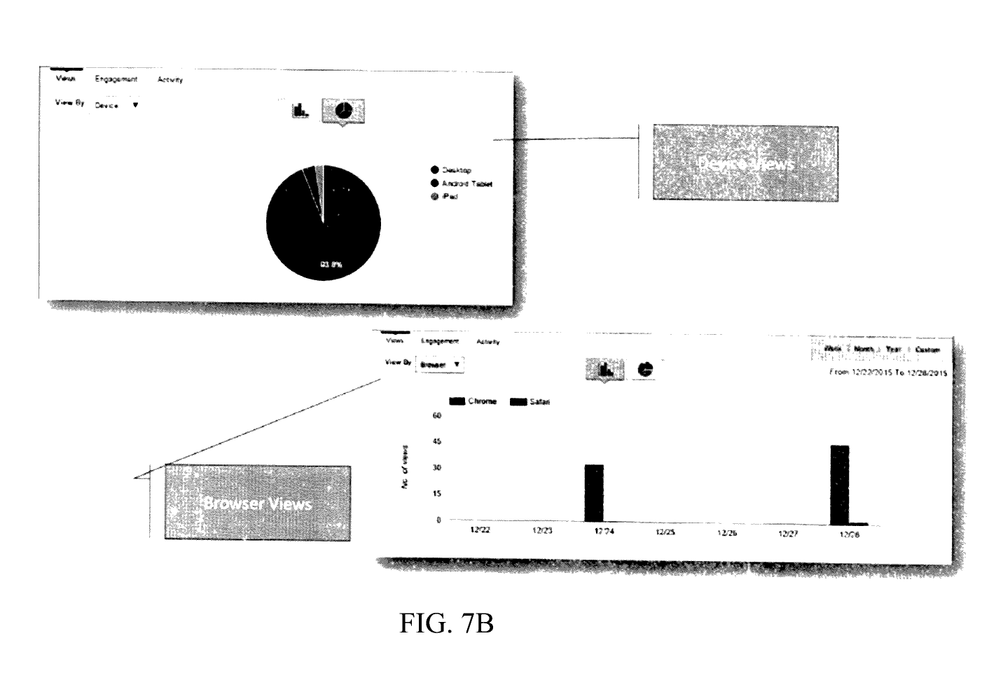

As per one of the preferred embodiment as depicted in the FIG. 3, a system for creating interactive user workflow comprise of an application user interface screen, a video processing module, instructor processor module, a video player module, a time event engine module, an analytics engine module, and a system process control module. The application user interface screen facilitate an interactive user interface. The video processing module comprise of a processor and memory to for receiving storing and making available for further processing at least one video file. The instructor processor module comprise of a processor and memory for receiving storing and making available for further processing at least one event instruction set. The video player module plays the video files. The time event engine module comprise of a processor to evaluate time events defined in the event instruction set by time event engine and execute an instruction to achieve desired effect when match is found between a defined time event and the video play time. The analytics engine module comprise of a processor, memory tracking the behaviour of the viewer/user and generating analytics based on the events, interactive and tracked data by the analytic engine. The system process control module configured to initiates and synchronize execution of various modules constituting the system configured to create and configure interactive user workflow.

As per one of the preferred embodiment of the present invention, the system and the method thereof create a single screen workflow experience that includes both video and user inputs in the same space.

As per one of the preferred embodiment of the present invention, the system and the method thereof allow a Cloud hosted interactive video to securely display private data and controls from a web application hosted in a separate domain.

As per one of the preferred embodiment of the present invention, the system and the method thereof allow a plurality of interactive videos offered through at least one hosted services such as but not limited to cloud hosted interactive video, to display controls that allow a user to interact with the web application hosted in a separate domain.

As per one of the preferred embodiment of the present invention, the system and the method thereof allow an interactive video designer with little or no software development skill to present private data and controls from an application hosted in a separate domain.

As per one of the preferred embodiment of the present invention, the system and the method thereof allow an interactive video to present private data without needing to change the security profile of the web application

As per one of the preferred embodiment of the present invention, the system and the method thereof allow the interactive video designer to visualize when and where dynamic data or controls will be displayed in the video during an editing process where it is not connected to the web application.

As per one of the preferred embodiment of the present invention, the system and the method thereof provide a means to manage the presentation of the data controls in the web application in a manner that can be updated to support new web standards without needed to edit previously created video.

As per one of the preferred embodiment of the present invention, the system and the method thereof present dynamic data and controls in away that supports the existing user interface design conventions of a web application.

As per one of the preferred embodiment of the present invention, it is still another object of the system and the method thereof of the invention to allow the existing user interface of the web application to be adjusted as needed to insure aesthetic compatibly with the underling video.

As per one of the preferred embodiment of the present invention, it is still another object of the system and the method thereof of the invention to allow analytics to be collected pertaining to actions in the video.

As per one of the preferred embodiment of the present invention, it is still another object of the system and the method thereof of the invention to provide advanced methods that would allow a technically sophisticated user to extend the capabilities beyond what is supported through the application interface.

As per one of the preferred embodiment of the present invention, it is still another object of the system and the method thereof of the invention to allow web application data pertinent to the audience to programmatically control what segments of video are played.

As per one of the preferred embodiment of the present invention, it is still another object of the system and the method thereof of the invention to allow the interactive video player to be automatically updated in all places it is used.

As per one of the preferred embodiment of the present invention, another object of the system and the method thereof of the invention are to create dynamically personalized video in a method that uses minimal server side resources so as to maximize the number of interactive video requests that can be supported from a web server.

As per one of the preferred embodiment of the present invention, it is still another object of the system and the method thereof of the invention to allow the navigation of a video to be driven by application or data and user inputs.

As per one of the preferred embodiment of the present invention, it is still another object of the system and the method thereof of the invention to allow the video to respond effectively to error conditions resulting from invalid data input by the user.

As per one of the preferred embodiment of the present invention, it is still another object of the system and the method thereof of the invention to support video guided flows for products and services that are not just software.

As per one of the embodiment of the present invention, that the present invention may minimize manual intervention and generate and automate dynamic interactive video driven single screen user interface workflows that maximize the likelihood that a user will successfully complete a process.

As per one of the preferred embodiment of the present invention, the system and the method thereof wherein at least one set of rules/instructions, which when applied, causes the processor to provide with a perspective based on the given data which will be instrumental in providing dynamic interactive video driven single screen user interface workflows. The system may be able to refresh all the content previously generated using freshly available data on a periodic basis.

In some examples, the systems described herein, may include one or more processors, one or more forms of memory, one or more input devices/interfaces, one or more output devices/interfaces, and machine-readable instructions that when executed by the one or more processors cause the system to carry out the various operations, tasks, capabilities, etc., described above.

In some embodiments, the disclosed techniques can be implemented, at least in part, by computer program instructions encoded on a non-transitory computer-readable storage media in a machine-readable format, or on other non-transitory media or articles of manufacture. Such computing systems (and non-transitory computer-readable program instructions) can be configured according to at least some embodiments presented herein, including the processes described herein.

The programming instructions can be, for example, computer executable and/or logic implemented instructions. In some examples, a computing device is configured to provide various operations, functions, or actions in response to the programming instructions conveyed to the computing device by one or more of the computer readable medium, the computer recordable medium, and/or the communications medium. The non-transitory computer readable medium can also be distributed among multiple data storage elements, which could be remotely located from each other. The computing device that executes some or all of the stored instructions can be a microfabrication controller, or another computing platform. Alternatively, the computing device that executes some or all of the stored instructions could be remotely located computer system, such as a server.

Further, while one or more operations have been described as being performed by or otherwise related to certain modules, devices, or entities, the operations may be performed by or otherwise related to any module, device, or entity. As such, any function or operation that has been described as being performed by the device could alternatively be performed by a different server, by the cloud computing platform, or a combination thereof.

Further, the operations need not be performed in the disclosed order, although in some examples, an order may be preferred. Also, not all functions need to be performed to achieve the desired advantages of the disclosed system and method, and therefore not all functions are required.

While select examples of the disclosed system and method have been described, alterations and permutations of these examples will be apparent to those of ordinary skill in the art. Other changes, substitutions, and alterations are also possible without departing from the disclosed system and method in its broader aspects as set forth in the above description.

In view of the many different embodiments to which the above-described inventive concepts may be applied, it should be recognized that the detailed embodiments are illustrative only and should not be taken as limiting the scope of our invention. Rather, we claim as our invention all such modifications as come within the scope and spirit of the above description.

The present invention may overcome the challenges of the current scenario through the described system and method for creating interactive user workflows through a single screen user interface that guides a user through a software workflow process by merging user input controls with in the flow of a video and uses the video content to provide examples, information, and motivation in timed sequence with the display of user input controls.

We claim:

1. A method for creating interactive user workflow, the method comprises:
Inserting an interactive video player into an application user interface screen or use web browser based interactive video player;
Receiving at least one video file;
Receiving at least one event instruction set;
Playing the video files;
Evaluating time events defined in the event instruction set by time event engine;
Executing an instruction to achieve desired effect when a match is found between a defined time event and the video play time;
Tracking the behaviour of the viewer/user;
Generating analytics based on the events, interactive and tracked data by the analytic engine.

2. The method as claimed in claim 1, wherein the time events are defined in the instruction set based on the events expected to be executed and the interactive behaviour expected at the time event from at least one user.

3. The method as claimed in claim 2 wherein the time line event details includes but not limited to detailed properties about the appearance and behaviour of control and video played including display location, colour, size etc.

4. The method as claimed in claim 1, wherein by executing an instruction a user interface component is made to appear over the video at a defined location so that from a viewer's perspective the component appears as part of the video.

5. The method as claimed in claim 1, wherein by executing an instruction, the instruction in the instruction set allows the player and user input component to coordinate, so that the video player could pause or loop video while waiting for user inputs and the video player is allowed to continue playing upon receiving inputs from the user.

6. The method as claimed in claim 1, wherein a dynamic branching container could accept at least one data variable into a conditional statement that would select a segment of the video most relevant to the viewer.

7. The method as claimed in claim 1, wherein tracking the behaviour of the viewer includes but not limited to recording the time spent viewing each action of the video, and the actions taken on each input or control.

8. The method as claimed in claim 1, create a single screen workflow experience that includes both video and user inputs in the same space.

9. The method as claimed in claim 1, allow the interactive video designer to visualize when and where dynamic data or controls will be displayed in the video during an editing process.

10. The method as claimed in claim 1, allow analytics to be collected and reported pertaining to the actions taken by the viewer while viewing the video.

11. The method as claimed in claim 1, allow web application data pertinent to the audience to programmatically control what segments of video are played.

12. A system for creating interactive video based user workflow, the system comprise of:
an application user interface screen to facilitate an interactive user interface;
a video processing module comprise of a processor and memory for receiving storing and making available for further processing of at least one video file;
instructor processor module comprise of a processor and memory for receiving storing and making available for further processing of at least one event instruction set;
a video player module for playing the video files;
a time event engine module comprise of a processor to evaluate time events defined in the event instruction set by time event engine and execute an instruction to achieve desired effect when match is found between a defined time event and the video play time;
an analytics engine module comprise of a processor, memory tracking the behaviour of the viewer/user and generating analytics based on the events, interactive and tracked data by the analytic engine.
a system process control module configured to initiate and synchronize execution of various modules constituting the system configured to create and configure interactive user workflow.
